(19) United States
(12) Patent Application Publication
(10) Pub. No.: US 2009/0064011 A1
(43) Pub. Date: Mar. 5, 2009

(54) Generational views in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/897,797

(22) Filed: Aug. 30, 2007

(51) Int. Cl. G06F 3/048

(52) U.S. Cl. 715/764

(57) ABSTRACT

A method and system of generational views in a geo-spatial environment are disclosed. In one embodiment, a method of displaying a geo-spatial map includes obtaining a location request from a member of a community network, displaying a location associated with the location request on the geo-spatial map, obtaining a selection of a generational view associated with the location from the member, and displaying the generations view on the geo-spatial map. The method may include obtaining a resident associated with the generational view, and displaying the resident on the geo-spatial map. The method may also include obtaining genealogy data associated with the member, determining a relative of the member associated with the generational view based on the genealogy data, and displaying the genealogy data associated with the relative on the geo-spatial map.

### FIELD OF TECHNOLOGY

This disclosure relates generally to the technical field of communications, and in one embodiment, to a method and system of generational views in a geo-spatial environment.

### BACKGROUND

A community network may correspond to a social structure made of nodes which may include individuals and/or organizations, and links between the nodes. The links may correspond to varying degrees of social familiarity, from those of casual acquaintances to close familial bonds. Community networks may be tracked and maintained on web-based applications, enabling friends, business partners, and/or other individuals to connect with one another using a variety of tools. Additionally, formation of the community networks on the web-based applications may allow parties to connect with one another regardless of geographic proximity.

In online community networks, users may create profiles that include information such as a name, an address, contact information, picture, and/or other personal information. For example, a friend-based community network may allow users to upload photos to their profiles, while a business community network may allow users to include work experience, education, and/or references on their profiles. The online community networks may further allow profiles to be edited by other users. For example, users may be allowed to leave comments, testimonials, and/or recommendations on other users' profiles and/or associate the other users with uploaded pictures, video, and/or other media.

Connections, or links, may be made between users in an online community network. For example, two users on the friend-based community network may become ‘friends’ if both the users approve the connection. Similarly, a business connection may be made on a business community network if two users have worked together and/or are interested in collaborating on future work. Connections, or links, between users form the basis of the online community networks and community network theory in general.

Community networks are currently focused on connections with entities in the present. For example, a geo-spatial community network may display people, businesses, and/or organizations on a present-day map. However, users of the geo-spatial community network may be unable to view people, businesses, and/or organizations on the map in the past, or even in the future. Consequently, the users of the community network may be unable to establish connections with different generations of family and/or friends, or view generation-based information in the community network.

### SUMMARY OF THE DISCLOSURE

A method and system of generational views in a geo-spatial environment are disclosed. In one aspect, a method of displaying a geo-spatial map includes obtaining a location request from a member of a community network, displaying a location associated with the location request on the geo-spatial map, obtaining a selection of a generational view (e.g., may be associated with any one of a past, a present and a future) associated with the location from the member, and displaying the generational view on the geo-spatial map. The method may further include obtaining a resident associated with the generational view, and displaying the resident on the geo-spatial map.

The method may also include obtaining genealogy data (e.g., a name, a gender, a relation, a date of birth, a place of birth, a place of death, a date of death, a location, a picture, a spouse, contact information, an occupation, a birth order, a generation, a lineage, and/or a child, etc.) associated with the member, determining a relative of the member associated with the generational view based on the genealogy data, and displaying the genealogy data associated with the relative on the geo-spatial map. The genealogy data may be obtained from a genetic test, a public record, a relative of the member, a friend of the member, the member and/or member data associated with the community network.

In another aspect, a community network includes a member repository including a plurality of members, a geo-spatial repository including a plurality of locations on a geo-spatial map, a member management module configured to obtain member data associated with each of the members, and a generation management module configured to obtain a location request from one of the members, display one of the locations associated with the location request on the geo-spatial map, obtain a selection of a generational view (e.g., may be associated with any one of a past, a present and a future) associated with the one of the locations from the one of the members, and display the generational view on the geo-spatial map. The generation management module may further be configured to obtain a resident associated with the generational view, and display the resident on the geo-spatial map.

The member management module may be also configured to obtain genealogy data (e.g., name, gender, relation, date of birth, place of birth, place of death, date of death, location, picture, spouse, contact information, occupation, birth order, generation, lineage and/or child, etc.) associated with the one of the members, associate the genealogy data with a location on the geo-spatial map, and associate the genealogy data with the generational view. The generation management module may be configured to determine a relative of the one of the members associated with the generational view, and display the genealogy data associated with the relative on the geo-spatial map. The genealogy data may be obtained from a genetic test, a public record, a relative of the member, a friend of the member, the member and/or member data associated with the community network.

The generation management module may further be configured to obtain a generational view creation request from the one of the members, obtain one of the locations associated with the generational view creation request, enable creation of a generational view associated with the one of the locations from the one of the members, and display the generational view at the one of the locations on the geo-spatial map.

In yet another aspect, a method of obtaining data associated with a geo-spatial map includes obtaining a generational view creation request from a member of a community network, obtaining a location associated with the generational view creation request, enabling creation of a generational view (e.g., may be associated with any one of a past, a present and a future) associated with the location from the member, and displaying the generational view at the location on the geo-spatial map. The method may also include providing an editing tool to the member to assist with the creation of the generational view.

The method may further include obtaining a resident associated with the generational view, and displaying the resident at the location on the geo-spatial map. In addition, the method may include obtaining genealogy data associated with the member, determining a relative of the member associated with the generational view based on the genealogy data, displaying the relative at the location on the geo-spatial map, and displaying the genealogy data associated with the relative on the geo-spatial map.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network enabling generation of generational views in a geo-spatial environment, according to one embodiment.

FIG. 2 is a user interface view of selecting a generational view associated with a location, according to one embodiment.

FIG. 3 is a user interface view of finding a relative of a member in the generational view, according to one embodiment.

FIG. 4 is a user interface view of editing the generational view associated with the location, according to one embodiment.

FIG. 5 is a user interface view of creating a generational view using editing tools, according to one embodiment.

FIG. 6 is a user interface view displaying a genealogy chart associated with the member, according to one embodiment.

FIG. 7 is a flow chart of associating genealogy data with generational views in the geo-spatial environment, according to one embodiment.

FIG. 8 is a flow chart of displaying genealogy data associated with relative(s) of a member in a generational view, according to one embodiment.

FIG. 9 is a diagrammatic system view of a data processing system in which any of the embodiments disclosed herein may be performed, according to one embodiment.

FIG. 10 is a flow chart of adding relative(s) to a generational view, according to one embodiment.

FIG. 11A is a process flow of displaying a geo-spatial map, according to one embodiment.

FIG. 11B is a continuation of the process flow of FIG. 11A, illustrating additional processes, according to one embodiment.

FIG. 12A is a process flow of obtaining data associated with the geo-spatial map, according to one embodiment.

FIG. 12B is a continuation of the process flow of FIG. 12A, illustrating additional processes, according to one embodiment.

Other features of the present embodiments will be apparent from the accompanying drawings and from the detailed description that follows.

### DETAILED DESCRIPTION

A method and system of generational views in a geo-spatial environment are disclosed. In the following description, for the purposes of explanation, numerous specific details are set forth in order to provide a thorough understanding of the various embodiments. It will be evident, however, to one skilled in the art that the various embodiments may be practiced without these specific details.

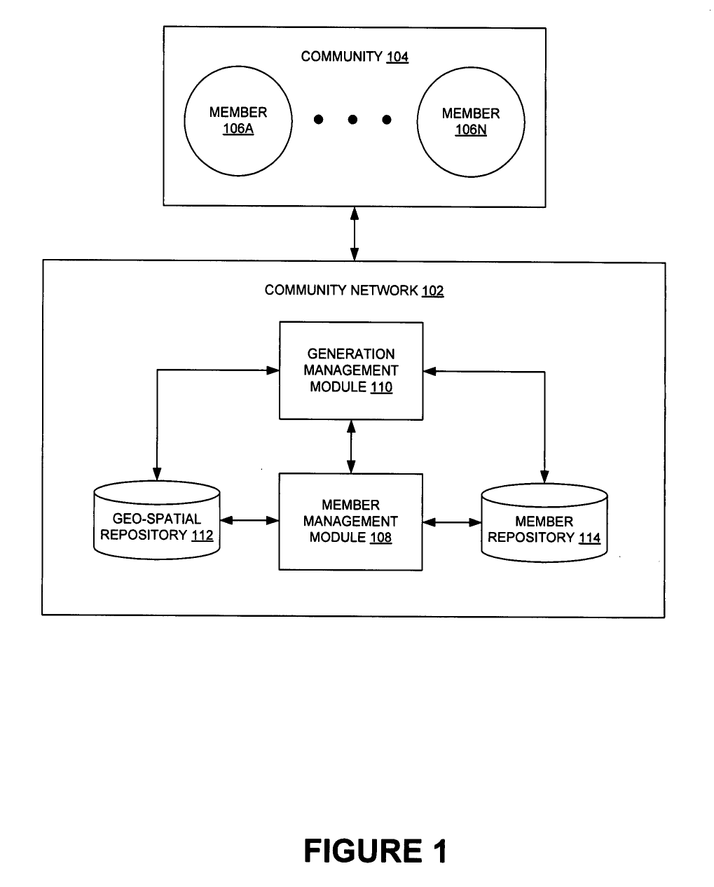

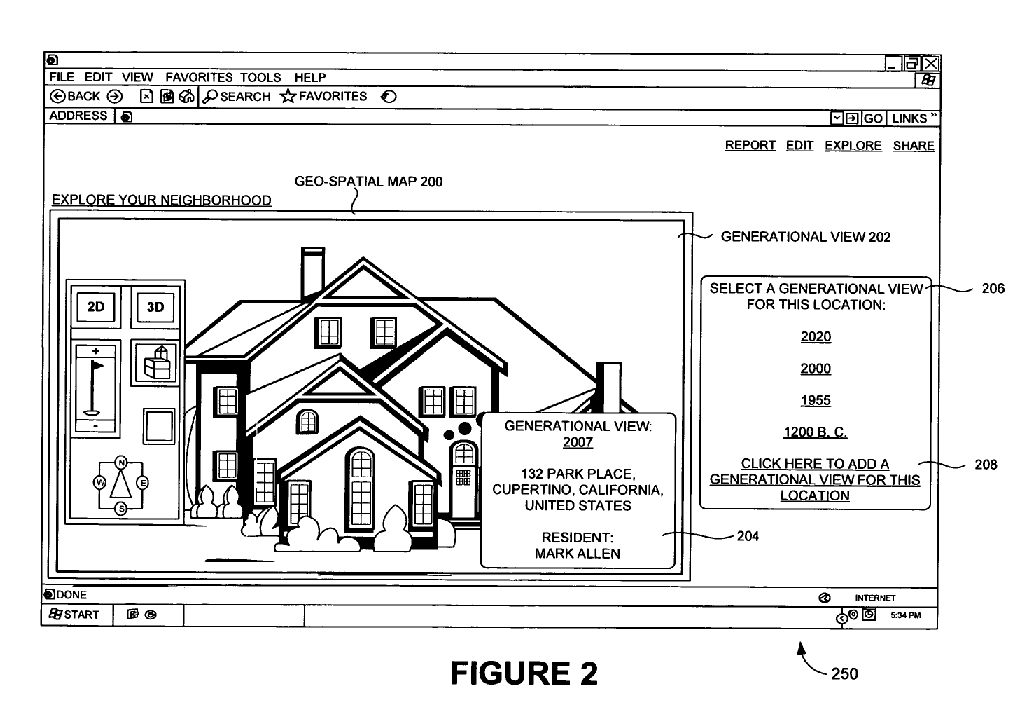

In one embodiment, a method of displaying a geo-spatial map (e.g., the geo-spatial map 200 of FIGS. 2-5) includes obtaining a location request from a member (e.g., of the members 106A-N of FIG. 1) of a community network (e.g., the community network 102 of FIG. 1), displaying a location associated with the location request on the geo-spatial map 200, obtaining a selection of a generational view (e.g., the generational view 202 of FIG. 2) associated with the location from the member 106, and displaying (e.g., using the generation management module 110 of FIG. 1) the generational view 202 on the geo-spatial map 200.

In another embodiment, a community network (e.g., the community network 102 of FIG. 1) includes a member repository (e.g., the member repository 114 of FIG. 1) including a number of members (e.g., the members 106A-N of FIG. 1), a geo-spatial repository (e.g., the geo-spatial repository 112 of FIG. 1) including a number of locations on a geo-spatial map (e.g., the geo-spatial map 200 of FIGS. 2-5), a member management module (e.g., the member management module 108 of FIG. 1) configured to obtain member data associated with each of the members 106A-N, and a generation management module (e.g., the generation management module 110 of FIG. 1) configured to obtain a location request from a member (e.g., of the number of members 106A-N), display a location (e.g., of the number of locations) associated with the location request on the geo-spatial map 200, obtain a selection of a generational view (e.g., the generational view 202 of FIG. 2) associated with the location from the member 106, and display the generational view 202 (e.g., using the generation management module 110 of FIG. 1) on the geo-spatial map 200.

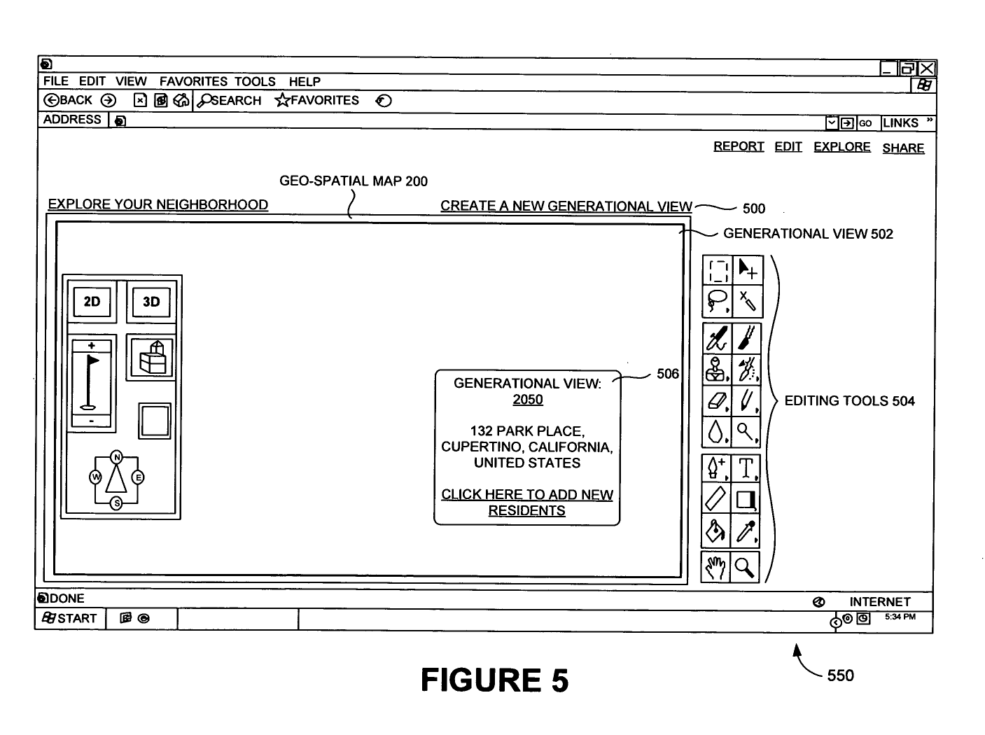

In yet another embodiment, a method of obtaining data associated with a geo-spatial map (e.g., the geo-spatial map 200 of FIGS. 2-4) includes obtaining a generational view creation request from a member (e.g., of the members 106A-N of FIG. 1) of a community network (e.g., the community network 102 of FIG. 1), obtaining a location associated with the generational view creation request, enabling creation of a generational view (e.g., the generational view 502 of FIG. 5) associated with the location from the member 106, and displaying the generational view 502 (e.g., using the generation management module 110 of FIG. 1) at the location on the geo-spatial map 200.

FIG. 1 is a system view of a community network 102 enabling generation of generational views in a geo-spatial environment, according to one embodiment. Particularly, FIG. 1 illustrates the community network 102, a community 104, members 106A-N, a member management module 108, a generation management module 110, a geo-spatial repository 112 and a member repository 114, according to one embodiment.

The community network 102 may be a network formed by association of the members 106A-N having user profiles associated with physical locations in the community 104. The user profiles may include information such as name, address, contact information (e.g., phone number and/or email address, etc.), picture, and/or personal information (e.g., hobbies and/or interests, etc.). In addition, the profiles of the members 106A-N may be editable by other members 106A-N of the community network 102.

In one example embodiment, the community network 102 may enable creation of generational views (e.g., the generational views 202, 302, 400 and 502 of FIGS. 2-5) associated with locations of the members 106A-N in the community 104. For example, the generational view 202 associated with a location may be user generated. The community 104 may refer to a group of members 106A-N residing in a specific region. For example, the specific region may be a neighborhood, a suburb, a village, a city, a county, a state, a nation, group of nations, etc. The members 106A-N may be individuals having user profiles associated with specific geographic locations in the community 104.

In an alternate embodiment, the members 106A-N may reside in multiple regions (e.g., multiple cities, states, countries, etc.). The members 106A-N may be connected through the community network 102, which may be accessible through a network (e.g., the internet). In one embodiment, the member management module 108 may obtain member data associated with each of the members 106A-N. For example, the member data may include name, age, profession and/or address data associated with the members 106A-N. The member data may be displayed in the profiles of the members 106A-N. In another embodiment, the member management module 108 may obtain the genealogy data associated with the members 106A-N of the community network 102.

The generation management module 110 may display a location corresponding to a location request on a geo-spatial map 200. The location request may be a search query provided by the member 106 of the community network 102. For example, the search query may include name, address, location, latitude/longitude, altitude, clicking on links, dragging and dropping marker, etc. In addition, the generation management module 110 may display a generational view (e.g., the generational view 202 of FIG. 2) associated with the location on the geo-spatial map 200. In one example embodiment, the generational view 202 may be displayed based on a selection of the generational view 202 by the member 106.

In another example embodiment, the generation management module 110 may enable creation (e.g., using the editing tools 504 of FIG. 5) of a generational view (e.g., the generational view 502 of FIG. 5) associated with a location based on a generational view creation request. The generational view creation request may be obtained from the member 106 of the community network 102. In addition, the generational view 502 (e.g., associated with any one of a past, a present and a future) may be displayed on a geo-spatial map (e.g., the geo-spatial map 200 of FIG. 5).

Further, the generation management module 110 may determine a relative(s) of the member 106 associated with the generational view (e.g., the generational views 202, 302, 400 and 502 of FIGS. 2-5). For example, the relative(s) may be an individual related to the member 106 by blood and/or marriage. In one example embodiment, the relative(s) of the member 106 may be determined based on genealogy data associated with the member 106 of the community 104. For example, the genealogy data may include name, gender, relation, date of birth, place of birth, date of birth, place of death, picture, spouse, occupation, birth order and/or lineage, etc. Further, the genealogy data may be obtained from genetic tests, public records, relative(s) of the members 106A-N, friends of the members 106A-N, the members 106A-N, and/or member data associated with the community network 102, etc.

In addition, the generation management module 110 may display residents associated with the generational view 302 and genealogy data associated with the relative(s) of the member 106 (e.g., associated with the generational view 302) on a geo-spatial map (e.g., the geo-spatial map 200 of FIG. 2). In one example embodiment, the residents associated with the generational view 302 may be relative(s) of the member 106 (e.g., who has provided the location request).

The geo-spatial repository 112 may be a database containing location information associated with the members 106A-N of the community 104. The member repository 114 may be a database containing member data associated with the members 106A-N of the community network 102. In one example embodiment, locations associated with the members 106A-N may be obtained based on the member data stored in the member repository 114.

In one embodiment, the member repository 114 may include a number of members 106A-N and the geo-spatial repository 112 may include a number of locations on a geo-spatial map 200. The member management module 108 may be configured to obtain member data associated with each of the members 106A-N. The member management module 108 may further be configured to obtain genealogy data (e.g., name, gender, relation, date of birth, place of birth, place of death, date of death, location, picture, spouse, contact information, occupation, birth order, generation, lineage and/or child, etc.) associated with a member 106, associate the genealogy data with a location on the geo-spatial map 200, and associate the genealogy data with the generational view (e.g., the generational view 202, 302 and 400 of FIG. 2-4).

The genealogy data may be obtained from a genetic test, a public record, a relative of the member 106, a friend of the member 106, the member 106, and/or member data associated with the community network 102. The generation management module 110 may be configured to obtain a location request from a member 106, and display a location associated with the location request on the geo-spatial map 200. The generation management module 110 may further be configured to obtain a selection of a generational view 202 associated with the location from the member 106, and display the generational view 202 (e.g., may be associated with any one of a past, a present and a future) on the geo-spatial map 200.

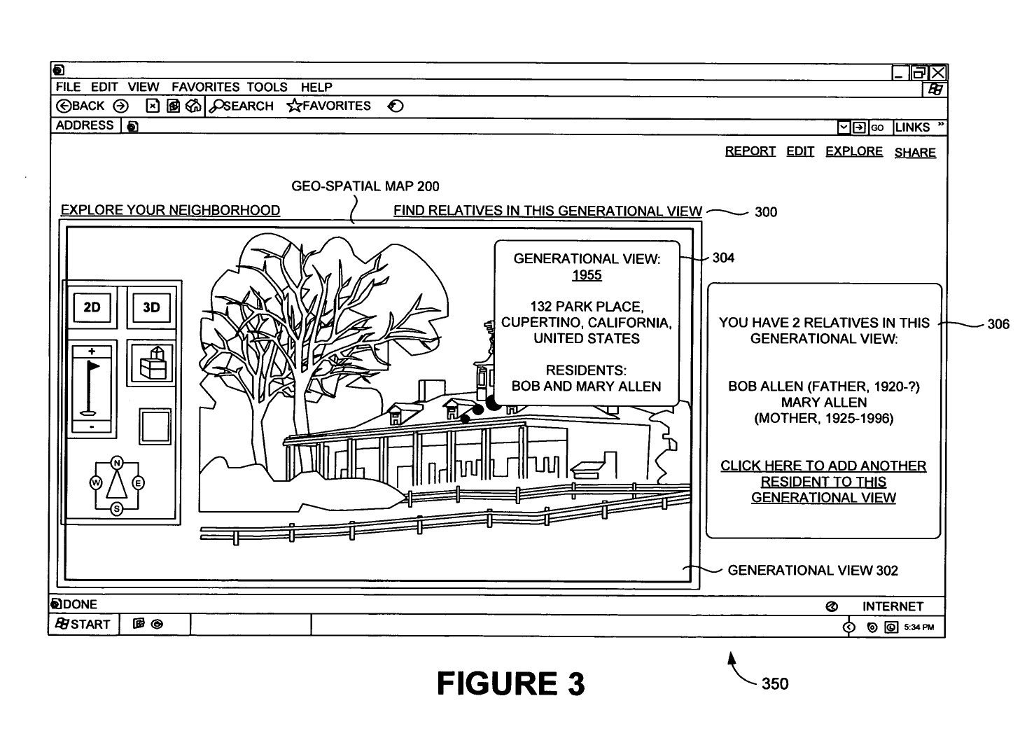

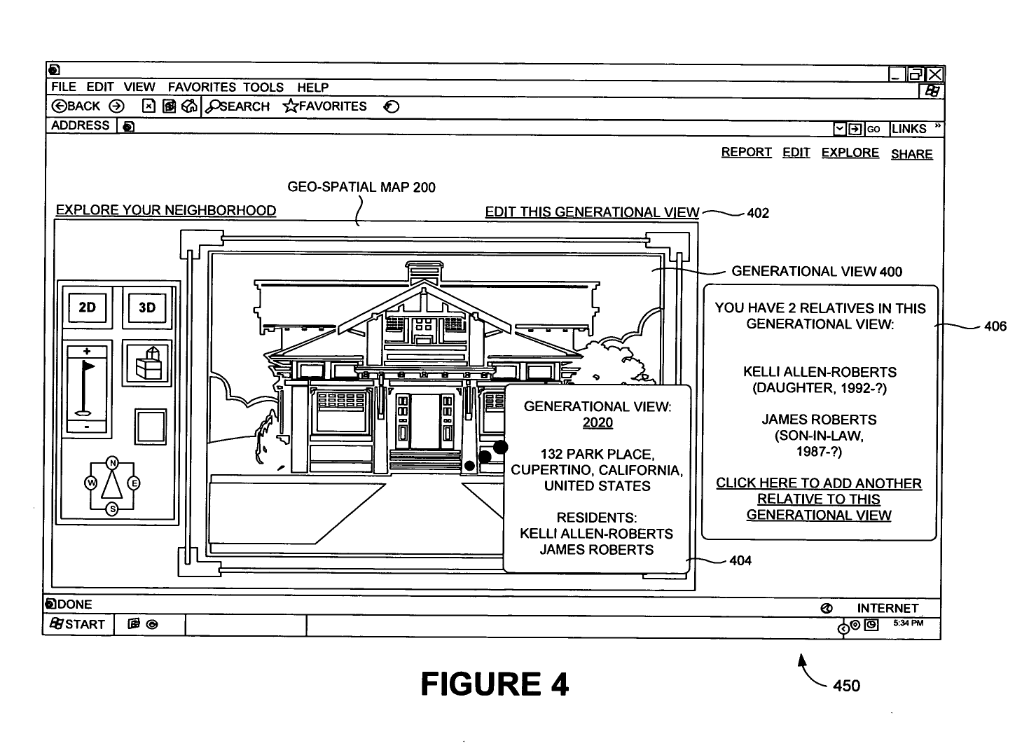

The generation management module 110 may also be configured to obtain a resident associated with the generational view (e.g., the generational view 302 of FIG. 3) and display the resident on the geo-spatial map 200. In addition, the generation management module 110 may be configured to determine a relative of the member 106 associated with the generational view (e.g., the generational view 400 of FIG. 4) and display the genealogy data associated with the relative on the geo-spatial map 200.

The generation management module 110 may further be configured to obtain a generational view creation request (e.g., through the create a new generational view option 500 of FIG. 5) from the member 106, and obtain a location associated with the generational view creation request. The generation management module 110 may be also configured to enable creation (e.g., using the editing tools 504 of FIG. 5) of a generational view (e.g., the generational view 502 of FIG. 5) associated with the location from the member 106, and display the generational view 502 at the location on the geo-spatial map 200.

FIG. 2 is a user interface view 250 of selecting a generational view 202 associated with a location, according to one embodiment. Particularly, FIG. 2 illustrates a geo-spatial map 200, the generational view 202, a profile block 204, a select a generational view for this location option 206 and a click here to add a generational view for this location option 208, according to one embodiment.

The geo-spatial map 200 may graphically visualize the generational view 202 associated with the location. The generational view 202 may be an image representing residences associated with the location. The generational view 202 may be associated with any one of a present, a past and a future view of physical structures associated with a particular location. The geo-spatial map 200 may also display resident(s) associated with the generational view 202 of the location. For example, if the member 106 select the generational view 202 (e.g., of the current year) associated with the location, the generational view 202 along with residents residing at the location may be displayed on the geo-spatial map 200.

The profile block 204 may display details of the residents associated with the generational view 202. For example, the details may include address of the location, resident(s), and/or year associated with the generational view 202. The select a generational view for this location option 206 may enable the member 106 of the community network 102 to select a generational view (e.g., the generational views 202, 302 and 400 of FIGS. 2-4) associated with any one of a past, a present and a future view of a particular location.

The click here to add a generational view for this location option 208 may enable the member 106 to add and/or create a new generational view (e.g., generational view 202 of FIG. 2) to the location displayed on the geo-spatial map 200. For example, the member 106 may add a generational view 202 associated with the location (e.g., corresponding to the address in the profile block 204) using the click here to add a generational view for this location option 208.

In the example embodiment illustrated in FIG. 2, the user interface view 250 displays the select a generational view for this location option 206 that enables the member 106 to select a particular generational view 202 (e.g., of the year 2007) associated with the location. The generational view 202 may be displayed on the geo-spatial map 200 along with the profile of the resident ‘Mark Allen’ associated with the generational view 202. The profile block 204 displays address of Mark Allen as ‘132 Park Place, Cupertino, Calif., United States’. The member 106 may also add another generational view for the location using the click here to add a generational view for this location option 208.

The user interface view 250 also displays a toolbar through which the member 106 may access the generational view 202 and/or the profile displayed in the profile block 204. For example, 2D option may allow the member 106 to visualize a two-dimensional view of generational view 202 on the geo-spatial map 200. The 3D option may enable the member 106 to generate a three-dimensional view of the generational view 202 on the geo-spatial map 200. The zoom control may enable the member 106 to zoom in or zoom out the generational view 202 to a desired scale on the geo-spatial map 200.

For example, a location request may be obtained (e.g., using the generation management module 110 of FIG. 1) from a member 106 of the community network 102, and a location associated with the location request may be displayed on the geo-spatial map 200. In addition, a selection of a generational view 202 (e.g., may be associated with any one of a past, a present and a future) associated with the location may be obtained (e.g., through the select a generational view for this location option 206) from the member 106 and the generational view 202 may be displayed on the geo-spatial map 200. A resident associated with the generational view 202 may also be obtained and displayed on the geo-spatial map 200.

FIG. 3 is a user interface view 350 of finding a relative(s) of the member 106 in a generational view 302 (e.g., associated with a past view of a residence), according to one embodiment. Particularly, FIG. 3 illustrates the geo-spatial map 200, a find relatives in this generational view option 300, the generational view 302, a profile block 304 and a block 306, according to one embodiment.

The find relatives in this generational view option 300 may enable the member 106 of the community network 102 to trace relative(s) associated with the generational view 302. For example, the relative(s) may be determined based on genealogy data associated with the member 106. The genealogy data may include name, gender, relation, date of birth, place of birth, date of death, place of death, picture, spouse, occupation, birth order, and/or lineage, etc. The generational view 302 may be a past view of a residence associated with relative(s) (e.g., Bob Allen and Mary Allen) of the member 106.

The profile block 304 may display details of residents associated with the generational view 302. For example, the details may include address of the location, resident(s), and/or year associated with the generational view 302, etc. The block 306 may display information such as number of relative(s) in the generational view 302. In one example embodiment, the block 306 may display a unique identifier (e.g., name, date of birth, relationship with the member 106, etc.) associated with relative(s) of the member 106 and genealogy data associated with the relative(s) on the geo-spatial map 200. The block 306 also displays a link through which the member 106 may add another resident(s) to the generational view 302.

In the example embodiment illustrated in FIG. 3, the user interface view 350 displays the generational view 302 (e.g., on the geo-spatial map 200) associated with ‘132 Park Place, Cupertino, Calif., United States’ of the year 1955. The member 106 may be enabled to find relative(s) associated with the generational view 302 using the find relative(s) in this generational view option 300. The genealogy data associated with the member 106 and the relative(s) may be displayed on the geo-spatial map 200. The block 306 displays residents, ‘Bob Allen’ and ‘Mary Allen’ of 132 Park Place, Cupertino, Calif., United States as relative(s) (e.g., based on the genealogy data) of Mark Allen. The user interface view 350 also displays options that may enable Mark Allen to add residents to the generational view 302 associated with 132 Park Place, Cupertino, Calif., United States.

In one embodiment, the genealogy data (e.g., name, gender, relation, date of birth, place of birth, place of death, date of death, location, picture, spouse, contact information, occupation, birth order, generation, lineage, and/or child, etc.) associated with the member 106 may be obtained. In addition, a relative of the member 106 associated with the generational view 302 may be determined based on the genealogy data. In another embodiment, the genealogy data associated with the relative may be displayed on the geo-spatial map 200. For example, the genealogy data may be obtained from a genetic test, a public record, a relative of the member 106, a friend of the member 106, the member 106 and/or member data associated with the community network 102.

FIG. 4 is a user interface view 450 of editing a generational view 400 (e.g., associated with a future view of a residence) associated with the location, according to one embodiment. Particularly, FIG. 4 illustrates the geo-spatial map 200, the generational view 400, an edit this generational view option 402, a profile block 404 and a block 406, according to one embodiment.

The generational view 400 may be a future view of a residence associated with relative(s) (e.g., Kelli Allen-Roberts and James Roberts) of the member 106. For example, the generational view 400 may be of a future period. The edit this generational view option 402 may enable the member 106 to add residents and/or relative(s) to the generational view 400. For example, the member 106 may add relative(s) and edit genealogical data associated with the relative(s) of the member 106.

The profile block 404 may display details of the residents associated with the location. For example, the details may include address associated with the generational view 400, the resident(s) associated with the generational view 400, and/or year of the generational view 400, etc. The block 406 may display the relative(s) of the member 106 associated with the generational view 400. For example, the relative(s) may be determined based on the genealogy data associated with the member 106.

In the example embodiment illustrated in FIG. 4, the user interface view 450 displays the generational view 400 (e.g., on the geo-spatial map 200) associated with ‘132 Park Place, Cupertino, Calif., United States’ of the year 2020. The profile block 404 displays residents associated with 132 Park Place, Cupertino, Calif., United States as ‘Kelli Allen-Roberts and James Roberts’. Kelli Allen-Roberts (e.g., daughter) and James Roberts (e.g., son-in-law) are relatives of Mark Allen (e.g., the member 106). Mark Allen may also add another relative(s) to the generational view 400 through an option in the block 406.

FIG. 5 is a user interface view 550 of creating a generational view (e.g., the generational view 502) using the editing tools 504, according to one embodiment. Particularly, FIG. 5 illustrates a create a new generational view option 500, the generational view 502, the editing tools 504 and a profile block 506, according to one embodiment.

The create a new generational view option 500 may enable the member 106 to create a new generational view 502 associated with the location using the editing tools 504. The generational view 502 may be an image of a residence associated with any one of a past, present and future view created by the member 106. For example, the editing tools 504 may be intended to provide enhanced editing functionality in the generational view 502. The profile block 506 may display details of residents associated with the generational view 502. For example, the details may include an address of a location (e.g., associated with the generational view 502), resident(s) associated with the generational view 502, and/or year of the generational view 502, etc.

In the example embodiment illustrated in FIG. 5, the user interface view 550 displays the editing tools 504 for creating generational view associated with ‘132 Park Place, Cupertino, Calif., United States. The member 106 may add new resident(s) to 132 Park Place, Cupertino, Calif., United States upon creating the generational view 502 (e.g., using the create a new generational view option 500).

As illustrated in FIG. 5, a generational view creation request may be obtained from a member 106 of the community network 102 and a location associated with the generational view creation request may be obtained (e.g., using the generation management module 110 of FIG. 1). Further, the member 106 may be enabled to create the generational view 502 (e.g., may be associated with any one of a past, a present and a future) associated with the location. The generational view 502 may be displayed at the location on the geo-spatial map 200. For example, the editing tools 504 may be provided to the member 106 to assist with the creation of the generational view 502.

In one embodiment, a resident associated with the generational view 502 may be obtained and displayed at the location on the geo-spatial map 200. In another embodiment, genealogy data associated with the member 106 may be obtained, and a relative of the member 106 associated with the generational view 502 may be determined based on the genealogy data. For example, the relative and the genealogy data associated with the relative may be displayed on the geo-spatial map 200.

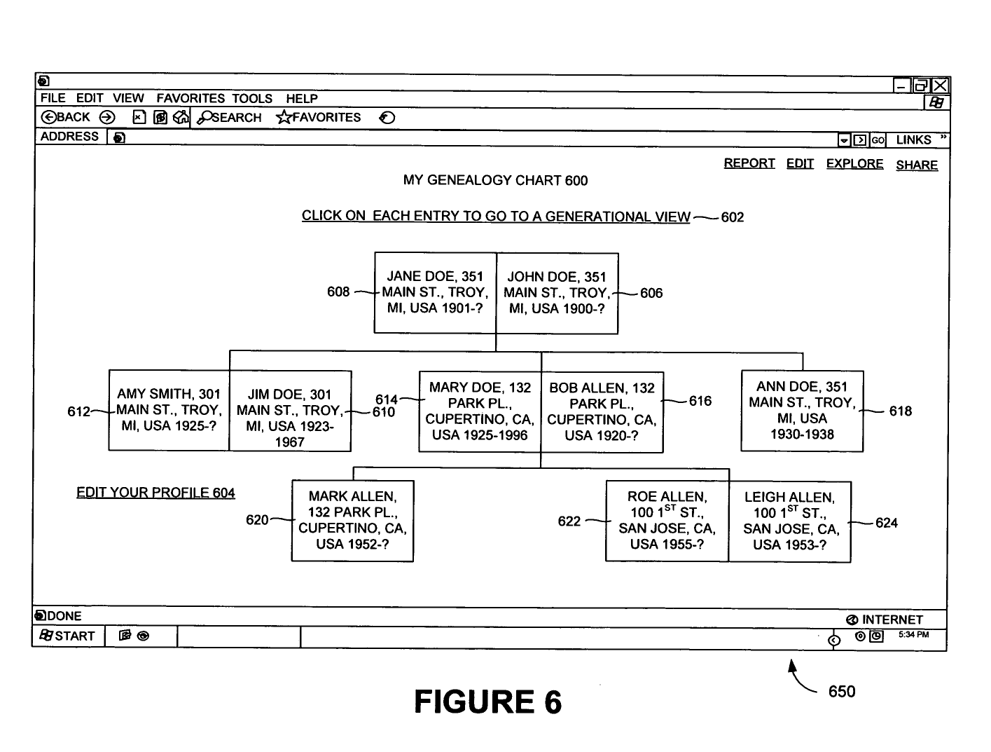

FIG. 6 is a user interface view 650 displaying a genealogy chart 600 associated with a member 106, according to one embodiment. Particularly, FIG. 6 illustrates the my genealogy chart 600, a click on each entry to go to a generational view option 602, an edit your profile option 604 and blocks 606-624 displaying genealogy data of the member 106 and relatives, according to one embodiment.

The my genealogy chart 600 may display details of the relative(s) associated with the member 106 in the form of a chart (e.g., a pedigree chart). For example, the details may include a unique identifier, location associated with the relative(s), date of birth, and/or date of death, etc. The click on each entry to go to a generational view option 602 may enable the member 106 to view generational views (e.g., the generational views 202, 302, 400 of FIGS. 2-4) associated with the relative(s) displayed in the my genealogy chart 600. The generational view may represent a location associated with any one of a past, a present and a future on the geo-spatial map 200. The edit your profile option 604 may enable the member 106 to edit information in the profiles associated with the member 106. The profile information may include name, profession, gender, address, date of birth, and/or spouse, etc.

In the example embodiment illustrated in FIG. 6, the user interface view 650 displays the my genealogy chart 600 associated with ‘Mark Allen’ resident of ‘132, Park Place, Cupertino, Calif., United States’. The user interface view 650 displays genealogy data associated with Mark Allen's grandpa, grandma, father, mother, aunts, uncle, sibling and brother-in-law in blocks 606, 608, 612, 614, 616, 618, 622 and 624 respectively, in addition to genealogy data associated with Mark Allen displayed in the block 620.

For example, the my genealogy chart 600 displays parents of Mark Allen, ‘Mary Doe’ and ‘Bob Allen’. The my genealogy chart 600 also displays that Mary Doe, mother of Mark Allen, was deceased at the age of 71 years and was one of the descendants of ‘Jane Doe’ and ‘John Doe,’ residents of ‘351, Main St., Troy, Mich., USA’. The other descendants of Jane Doe and John Doe are ‘Jim Doe’ and ‘Ann Doe,’ as illustrated in user interface view 650. The my genealogy chart 600 displays Ann Doe, who was residing in the same location as Jane Doe and John doe and was deceased at the age of 8 years of age, and that Jim Doe is the spouse of ‘Amy Smith’, both residing at ‘301, Main St., Troy, Mich., USA’. In addition, the my genealogy chart 600 illustrates that Mark Allen has one sibling, ‘Roe Allen’ spouse of ‘Leigh Allen’ residing at ‘100 1^{st} St., San Jose, Calif., USA’.

In one example embodiment, Mark Allen may be enabled to edit (e.g., modify, add, and/or update, etc.) his profile through the edit your profile option 604. Also, Mark Allen may view a generational view associated with each of his relatives through clicking on each entry. For example, different generational views (e.g., the generational view 202 of FIG. 2 and the generational view 302 of FIG. 3) associated with 132, Park Place, Cupertino, Calif., United States may be obtained by clicking on block 620 and the block 614 of the my genealogy chart 600.

The generational view 202 associated with Mark Allen (e.g., obtained through clicking on the block 620) may be a present generational view displaying an image of the residence and/or genealogy data associated with Mark Allen. Similarly, the generational view 302 associated with Mary Doe (e.g., obtained through clicking on block 614) may be a generational view related to the past, displaying an image of a residence and genealogy data associated with Mary Doe (e.g., spouse of Bob Allen). Thus, genealogy data (e.g., date of birth, address, date of death, etc.) and generational view associated with Mark Allen and his relative(s) may be conveniently viewed through the my genealogy chart 600.

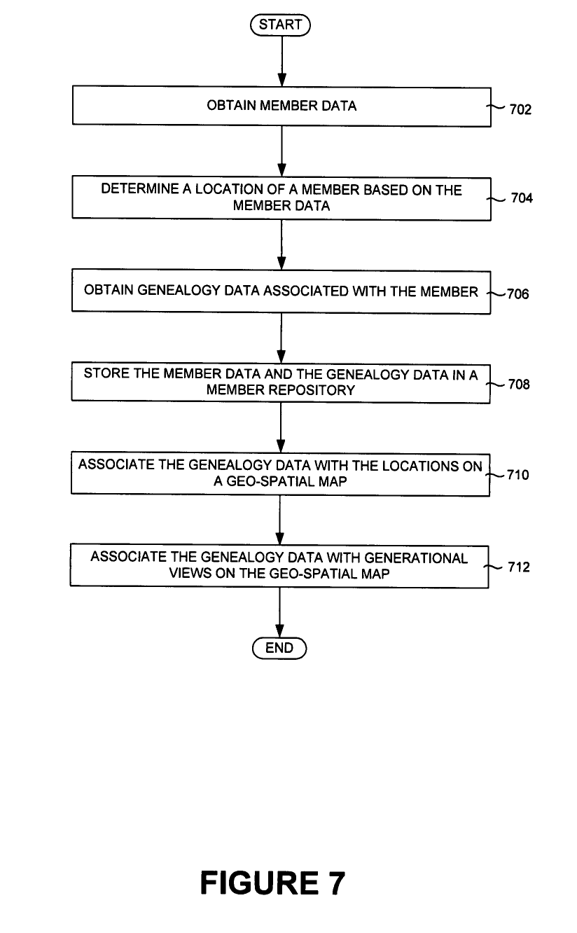

FIG. 7 is a flow chart of associating genealogy data with generational views (e.g., the generational views 202, 302, 400 and 502 of FIGS. 2-5) in a geo-spatial environment, according to one embodiment. In operation 702, member data associated with members 106A-N is obtained (e.g., using the member management module 108 of FIG. 1). For example, the member data may include age, gender, profession, and/or address data, etc. In operation 704, a location of a member 106 is determined (e.g., using the generation management module 110 of FIG. 1) based on the member data. For example, a particular location may be identified on a geo-spatial map 200 using the member data (e.g., may include location information).

In operation 706, genealogy data associated with the member 106 is obtained (e.g., using the member management module 108 of FIG. 1). In one or more embodiments, the genealogy data associated with the member 106 may be obtained from genetic tests, public records, relative(s) of the members 106A-N, friends of the members 106A-N, the members 106A-N, and/or member data associated with the community network 102, etc. For example, the genealogy data may include name, gender, relation, date of birth, place of birth, date of death, place of death, picture, spouse, occupation, birth order, and/or lineage, etc.

In operation 708, the member data and the genealogy data are stored in the member repository (e.g., the member repository 114 of FIG. 1). In one or more embodiments, the locations of the members 106A-N are determined based on the member data stored in the member repository 114. Also, the genealogy data may be used to determine the relative(s) of the members 106A-N. In operation 710, the genealogy data is associated with the locations on a geo-spatial map 200. In operation 712, the genealogy data is associated with the generational views (e.g., the generational views 202, 302, 400, 502 of FIGS. 2-5) on the geo-spatial map 200. For example, the generational views may be associated with any one of a past, a present and a future.

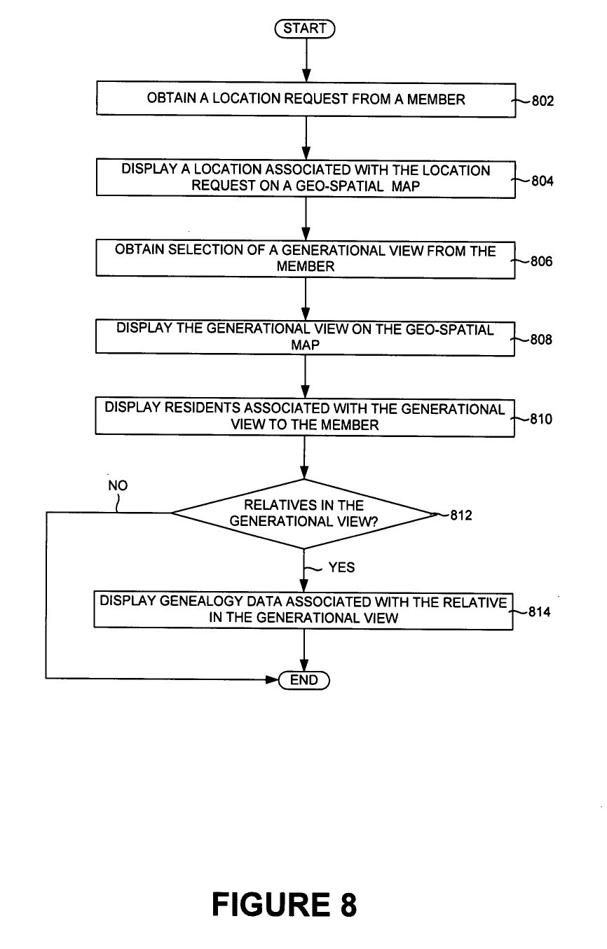

FIG. 8 is a flow chart of displaying genealogy data associated with relative(s) of a member 106 in a generational view (e.g., the generational view 400 of FIG. 4), according to one embodiment. In operation 802, a location request is obtained from a member 106. The location request may be obtained through a search query provided by the member 106 of the community network 102. For example, the search query may include name, address (e.g., street, address, city, state, zip code, and/or county, etc.), latitude/longitude, altitude, click on a map, dragging and dropping, etc. In operation 804, a location corresponding to the location request is displayed on a geo-spatial map 200.

In operation 806, a selection of a generational view 400 is obtained from the member 106. For example, the generational view 400 may be obtained from a number of generational views associated with the location requested by the member 106. In operation 808, the generational view 400 is displayed on the geo-spatial map 200. The generational view 400 may be user generated and associated with a past, a present or a future. In addition, the generational view 400 may be displayed (e.g., on the geo-spatial map 200) at the location requested by the member 106.

In operation 810, residents associated with the generational view 400 are displayed to the member 106. For example, the residents may be relative(s) of the member 106 associated with the generational view 400, displayed at the location on the geo-spatial map 200. In operation 812, a check is performed regarding a determination of relative(s) in the generational view 400 displayed on the geo-spatial map 200. For example, the relative(s) may be determined based on the genealogy data associated with the members 106A-N. If no relative(s) of the members 106A-N are determined then the process may terminate. Once the relative(s) associated with the generational view 400 of the location are determined, the genealogy data associated with the relative(s) is displayed in the generational view 400 in operation 814.

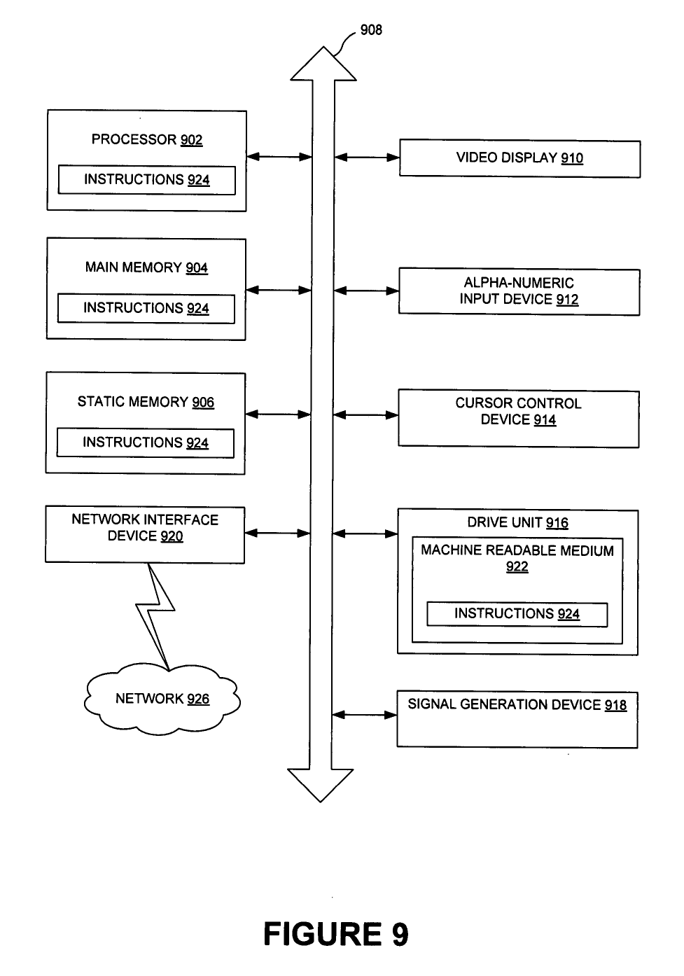

FIG. 9 is a diagrammatic system view 900 of a data processing system in which any of the embodiments disclosed herein may be performed, according to one embodiment. Particularly, the diagrammatic system view 900 of FIG. 9 illustrates a processor 902, a main memory 904, a static memory 906, a bus 908, a video display 910, an alpha-numeric input device 912, a cursor control device 914, a drive unit 916, a signal generation device 918, a network interface device 920, a machine readable medium 922, instructions 924 and a network 926, according to one embodiment.

The diagrammatic system view 900 may indicate a personal computer and/or a data processing system in which one or more operations disclosed herein are performed. The processor 902 may be microprocessor, a state machine, an application specific integrated circuit, a field programmable gate array, etc. (e.g., Intel® Pentium® processor). The main memory 904 may be a dynamic random access memory and/or a primary memory of a computer system.

The static memory 906 may be a hard drive, a flash drive, and/or other memory information associated with the data processing system. The bus 908 may be an interconnection between various circuits and/or structures of the data processing system. The video display 910 may provide graphical representation of information on the data processing system. The alpha-numeric input device 912 may be a keypad, keyboard and/or any other input device of text (e.g., special device to aid the physically handicapped). The cursor control device 914 may be a pointing device such as a mouse.

The drive unit 916 may be the hard drive, a storage system, and/or other longer term storage subsystem. The signal generation device 918 may be a bios and/or a functional operating system of the data processing system. The network interface device 920 may be a device that may perform interface functions such as code conversion, protocol conversion and/or buffering required for communication to and from a network. The machine readable medium 922 may provide instructions on which any of the methods disclosed herein may be performed. The instructions 924 may provide source code and/or data code to the processor 902 to enable any one or more operations disclosed herein.

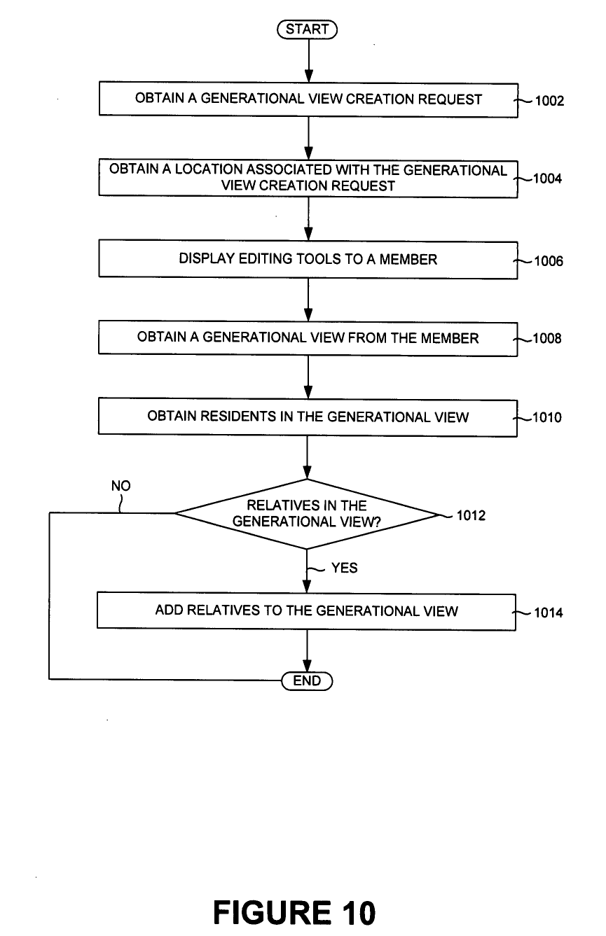

FIG. 10 is a flow chart of adding relative(s) to a generational view (e.g., the generational view 400 of FIG. 4), according to one embodiment. In operation 1002, a generational view creation request is obtained from the member 106 of the community network 102. For example, the generational view 400 may be created at a location requested by the members 106A-N viewable on a geo-spatial map 200. In operation 1004, a location associated with the generational view creation request is obtained. For example, the location is displayed on the geo-spatial map 200. In operation 1006, editing tools (e.g., the editing tools 504 of FIG. 5) are displayed to the member 106. For example, the editing tools 504 may provide enhanced editing functionality in the generational view 400.

In operation 1008, a generational view 400 is obtained from the member 106. In operation 1010, residents are obtained in the generational view 400. In operation 1012, a check is made to determine relative(s) associated with the member 106 (e.g., who has made the generational view creation request) in the generational view 400. If relative(s) do(es) not exist in the generational view 400 associated in the member 106, then the process may terminate. In operation 1014, relatives are added to the generational view 400 associated with the member 106.

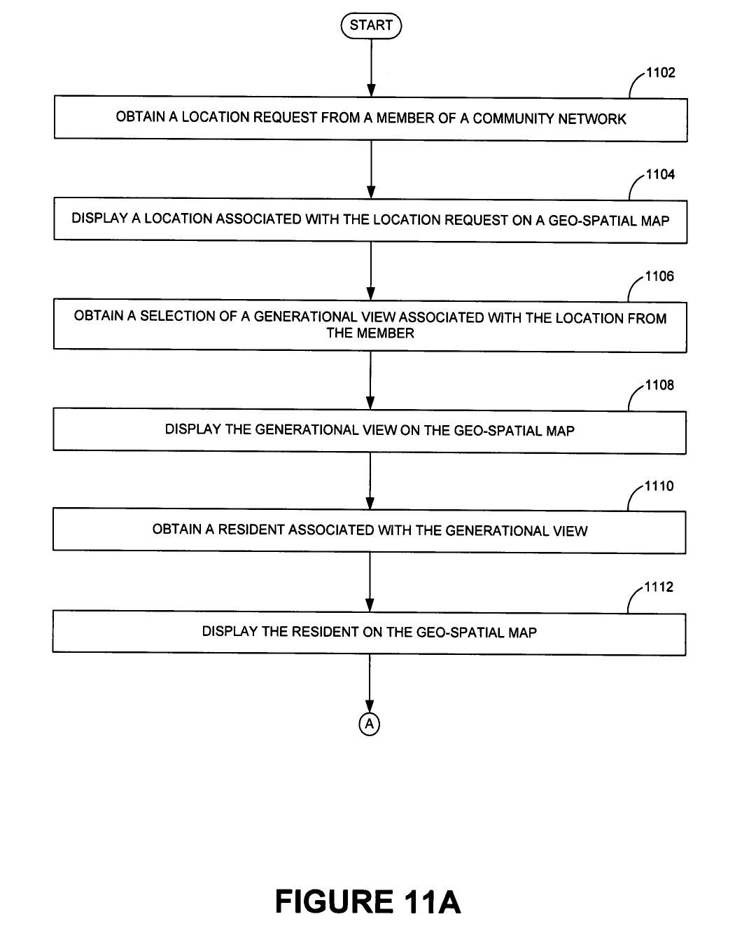

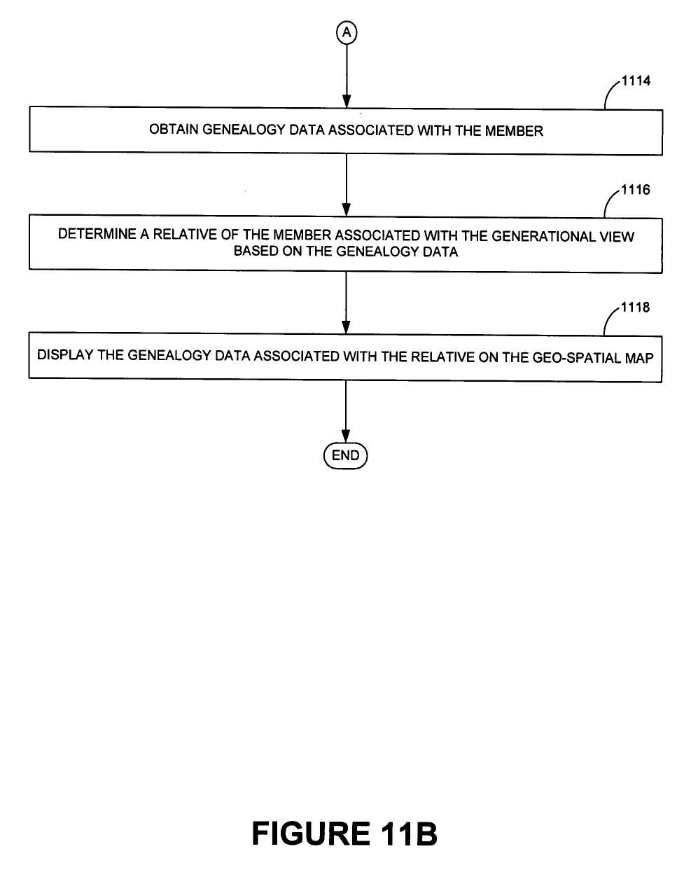

FIG. 11A is a process flow of displaying a geo-spatial map (e.g., the geo-spatial map 200 of FIG. 2, 3 and 4), according to one embodiment. In operation 1102, a location request may be obtained from a member (e.g., of the members 106A-N of FIG. 1) of a community network (e.g., the community network 102 of FIG. 1). In operation 1104, a location associated with the location request may be displayed (e.g., using the generation management module 110 of FIG. 1) on the geo-spatial map 200.

In operation 1106, a selection of a generational view (e.g., the generational view 202 of FIG. 2) associated with the location may be obtained (e.g., through the generation management module 110 of FIG. 1) from the member 106. In operation 1108, the generational view 202 may be displayed (e.g., using the generation management module 110 of FIG. 1) on the geo-spatial map 200. In operation 1110, a resident associated with the generational view 202 may be obtained (e.g., through the generation management module 110 of FIG. 1). In operation 1112, the resident may be displayed (e.g., using the generation management module 110 of FIG. 1) on the geo-spatial map 200.

FIG. 11B is a continuation of the process flow of FIG. 11A, illustrating additional processes, according to one embodiment. In operation 1114, genealogy data associated with the member 106 may be obtained (e.g., using the member management module 108 of FIG. 1). In operation 1116, a relative of the member 106 associated with the generational view (e.g., the generational view 302 of FIG. 3) may be determined (e.g., using the generation management module 110 of FIG. 1) based on the genealogy data. In operation 1118, the genealogy data associated with the relative may be displayed (e.g., using the generation management module 110 of FIG. 1) on the geo-spatial map 200.

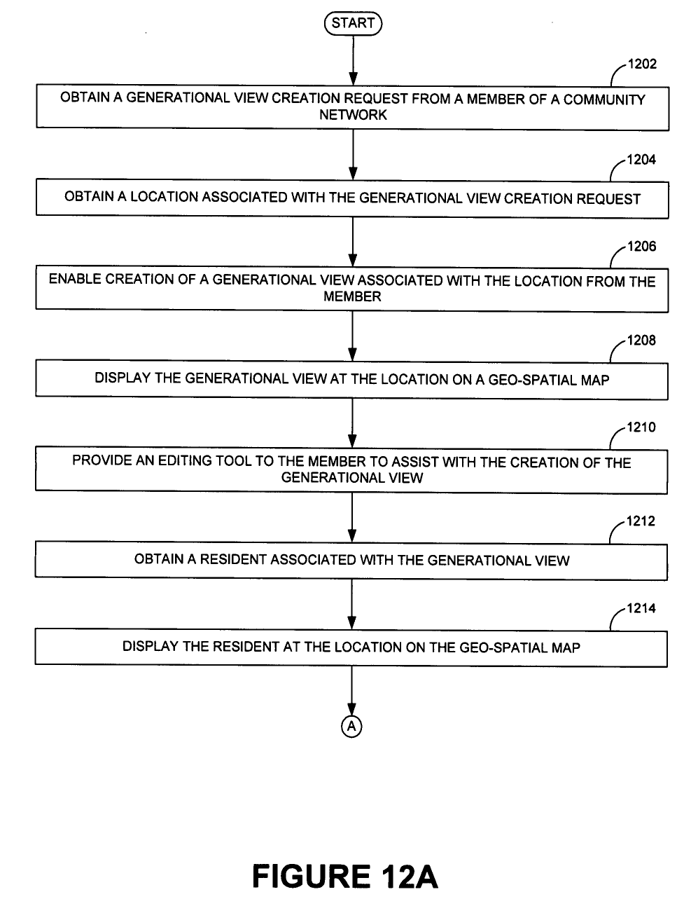

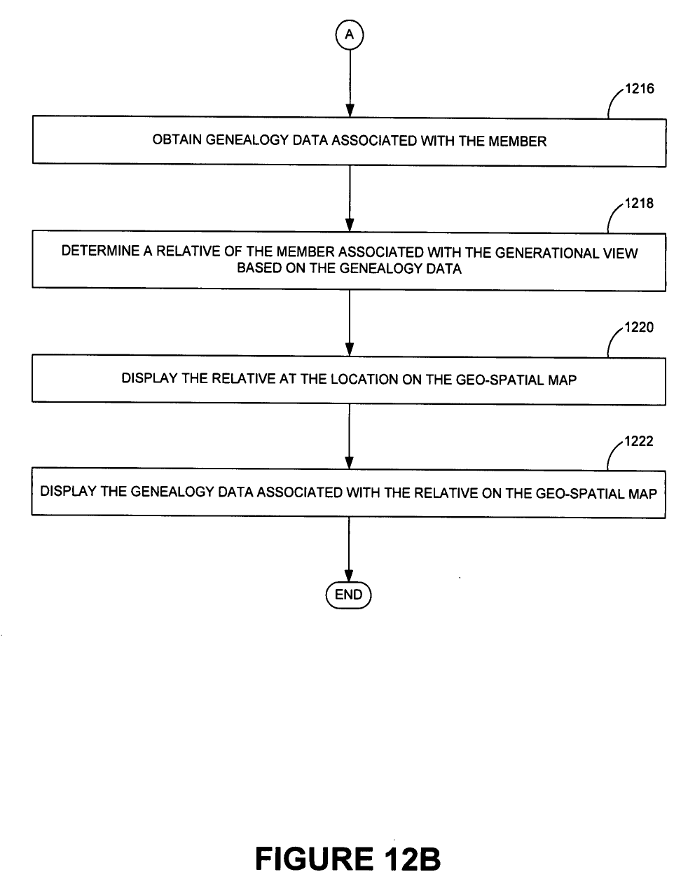

FIG. 12A is a process flow of obtaining data associated with a geo-spatial map (e.g., the geo-spatial map 200 of FIG. 5), according to one embodiment. In operation 1202, a generational view creation request may be obtained (e.g., through the generation management module 110 of FIG. 1) from a member 106 of a community network (e.g., the community network 102 of FIG. 1). In operation 1204, a location associated with the generational view creation request may be obtained (e.g., using the generation management module 110 of FIG. 1). In operation 1206, creation of a generational view (e.g., the generational view 502 of FIG. 5) associated with the location may be enabled from the member 106 (e.g., through the generation management module 110 of FIG. 1).

In operation 1208, the generational view 502 may be displayed (e.g., using the generation management module 110 of FIG. 1) at the location on the geo-spatial map 200. In operation 1210, an editing tool (e.g., the editing tools 504 of FIG. 5) may be provided (e.g., through the generation management module 110 of FIG. 1) to the member 106 to assist with the creation of the generational view 502. In operation 1212, a resident associated with the generational view 502 may be obtained (e.g., using the generation management module 110 of FIG. 1). In operation 1214, the resident may be displayed (e.g., using the generation management module 110 of FIG. 1) at the location on the geo-spatial map 200.

FIG. 12B is a continuation of the process flow of FIG. 12A, illustrating additional processes, according to one embodiment. In operation 1216, genealogy data associated with the member 106 may be obtained (e.g., using the member management module 108 of FIG. 1). In operation 1218, a relative of the member 106 associated with the generational view 502 may be determined (e.g., using the generation management module 110 of FIG. 1) based on the genealogy data. In operation 1220, the relative may be displayed (e.g., using the generation management module 110 of FIG. 1) at the location on the geo-spatial map 200. In operation 1222, the genealogy data associated with the relative may be displayed (e.g., using the generation management module 110 of FIG. 1) on the geo-spatial map 200.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 108, the generation management module 110 and other modules of FIGS. 1-12 may be may be enabled using a member management circuit, a generation management circuit and other circuits using one or more of the technologies described herein.

In addition, it will be appreciated that the various operations, processes and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of displaying a geo-spatial map, comprising:
obtaining a location request from a member of a community network;
displaying a location associated with the location request on the geo-spatial map;
obtaining a selection of a generational view associated with the location from the member; and
displaying the generational view on the geo-spatial map.

2. The method of claim 1, further comprising:
obtaining a resident associated with the generational view; and
displaying the resident on the geo-spatial map.

3. The method of claim 2, further comprising:
obtaining genealogy data associated with the member;
determining a relative of the member associated with the generational view based on the genealogy data; and
displaying the genealogy data associated with the relative on the geo-spatial map.

4. The method of claim 3, wherein the genealogy data is obtained from at least one of a genetic test, a public record, a relative of the member, a friend of the member, the member, and member data associated with the community network.

5. The method of claim 3, wherein the genealogy data is at least one of a name, a gender, a relation, a date of birth, a place of birth, a place of death, a date of death, a location, a picture, a spouse, contact information, an occupation, a birth order, a generation, a lineage, and a child.

6. The method of claim 1, wherein the generational view is associated with at least one of a past, a present, and a future.

7. The method of claim 1 in the form of a machine-readable medium embodying a set of instructions that, when executed by a machine, causes the machine to perform the method of claim 1.

8. A community network, comprising:
a member repository comprising a plurality of members;
a geo-spatial repository comprising a plurality of locations on a geo-spatial map;
a member management module configured to obtain member data associated with each of the plurality of members; and
a generation management module configured to:
obtain a location request from one of the plurality of members;
display one of the plurality of locations associated with the location request on the geo-spatial map;
obtain a selection of a generational view associated with the one of the plurality of locations from the one of the plurality of members; and
display the generational view on the geo-spatial map.

9. The community network of claim 8, wherein the generation management module is further configured to:
obtaining a resident associated with the generational view; and
display the resident on the geo-spatial map.

10. The community network of claim 8, wherein the member management module is further configured to:
obtain genealogy data associated with the one of the plurality of members;
associate the genealogy data with at least one of the plurality of locations on the geo-spatial map; and
associate the genealogy data with the generational view.

11. The community network of claim 10, wherein the generation management module is further configured to:
determine a relative of the one of the plurality of members associated with the generational view; and
display the genealogy data associated with the relative on the geo-spatial map.

12. The community network of claim 10, wherein the genealogy data is obtained from at least one of a genetic test, a public record, a relative of the member, a friend of the member, the member, and member data associated with the community network.

13. The community network of claim 10, wherein the genealogy data is at least one of a name, a gender, a relation, a date of birth, a place of birth, a place of death, a date of death, a location, a picture, a spouse, contact information, an occupation, a birth order, a generation, a lineage, and a child.

14. The community network of claim 8, wherein the generational view is associated with at least one of a past, a present, and a future.

15. The community network of claim 8, wherein the generation management module is further configured to:
obtain a generational view creation request from the one of the plurality of members;
obtain one of the plurality of locations associated with the generational view creation request;
enable creation of a generational view associated with the one of the plurality of locations from the one of the plurality of members; and
display the generational view at the one of the plurality of locations on the geo-spatial map.

16. A method of obtaining data associated with a geo-spatial map, comprising:
obtaining a generational view creation request from a member of a community network;
obtaining a location associated with the generational view creation request;
enabling creation of a generational view associated with the location from the member; and
displaying the generational view at the location on the geo-spatial map.

17. The method of claim 16, further comprising providing an editing tool to the member to assist with the creation of the generational view.

18. The method of claim 16, further comprising:
obtaining a resident associated with the generational view; and
displaying the resident at the location on the geo-spatial map.

19. The method of claim 16, further comprising:
obtaining genealogy data associated with the member;
determining a relative of the member associated with the generational view based on the genealogy data;
displaying the relative at the location on the geo-spatial map; and
displaying the genealogy data associated with the relative on the geo-spatial map.

20. The method of claim 16, wherein the generational view is associated with at least one of a past, a present, and a future.
